(19) United States
(12) Patent Application Publication
(10) Pub. No.: US 2026/0024986 A1
(43) Pub. Date: Jan. 22, 2026

(54) ENERGY STORAGE SYSTEM AND METHOD FOR CONTROLLING MOLDED CASE CIRCUIT BREAKER

(71) Applicant: SAMSUNG SDI CO., LTD., Yongin-Si Gyeonggi-do (KR)

(72) Inventors: Geonhwa MYUNG, Yongin-Si (KR); Dongyoun KANG, Yongin-Si (KR)

(21) Appl. No.: 19/240,115

(22) Filed: Jun. 17, 2025

(30) Foreign Application Priority Data
Jul. 17, 2024 (KR) 10-2024-0094656

(51) Int. Cl. H02H 7/18; H01M 10/42; H01M 10/48

(52) U.S. Cl. CPC H02H 7/18; H01M 10/425; H01M 10/48; H01M 2010/4271

(57) ABSTRACT

A method for controlling a molded case circuit breaker of an energy storage system includes collecting, by a master BMS, voltage information associated with a plurality of battery racks from a plurality of slave BMSs associated with the plurality of battery racks; calculating an average voltage of the plurality of battery racks based on the voltage information associated with the plurality of battery racks; and determining a state of a first molded case circuit breaker (MCCB) associated with a first battery rack among the plurality of battery racks based on the voltage information associated with the plurality of battery racks and the average voltage, wherein the first molded case circuit breaker is in a trip state.

### CROSS-REFERENCE TO RELATED APPLICATION

The present application claims priority to and the benefit of Korean Application No. 10-2024-0094656, filed on Jul. 17, 2024, in the Korean Intellectual Property Office, the entire disclosure of which is incorporated herein by reference.

### BACKGROUND

### 1. Field

Aspects of embodiments of the present disclosure relate to an energy storage system and a method for controlling a molded case circuit breaker thereof.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

An energy storage system (ESS) can connect renewable energy, such as wind or solar energy, whose power output cannot be controlled, to the existing power grid and charge or discharge the energy according to the power consumption pattern. In particular, a battery energy storage system using a secondary battery is not only used for stabilizing the grid voltage and frequency, but can also be linked with a renewable energy generation system with an unstable power generation amount, such as wind or solar power, to store surplus energy and supply energy to the load by discharging the energy stored in the battery.

In an energy storage system, efficient management of the battery is one of the important factors. By managing various matters such as battery charging, discharging, and cell balancing, the life of the battery can be extended, and power can be stably supplied to the load. For this purpose, the energy storage system may include a battery management system (BMS). The BMS may include a master BMS for controlling the entire battery management system and a slave BMS for controlling the state of each battery. The master BMS and the slave BMS may transmit and receive information using, for example, controller area network (CAN) communication.

The energy storage system may include a molded case circuit breaker (MCCB) that controls the flow of current supplied to a plurality of battery racks. The molded case circuit breaker may open the circuit between the battery rack and an external power device to block the line when an overcurrent is detected. When a problem occurs in the energy storage system, the molded case circuit breaker may be set to a trip state by the BMS to prevent current from flowing to the battery rack. After the problem is resolved and a trip state is released, the molded case circuit breaker may be switched to a closed state to supply current to the battery rack. At this time, as current flows to the plurality of battery racks momentarily, an inrush current may occur due to a voltage difference between the plurality of battery racks, which may cause the fuse of the molded case circuit breaker to break/blow. In addition, current may flow between the battery racks due to a voltage difference between the plurality of battery racks, which may cause unnecessary power loss.

The above information disclosed in this Background section is for enhancement of understanding of the background of the present disclosure, and therefore, it may contain information that does not constitute related (or prior) art.

### SUMMARY

Aspects of some embodiments of the present disclosure are directed to an energy storage system and a method for controlling a molded case circuit breaker thereof.

These and other aspects and features of the present disclosure will be described in or will be apparent from the following description of embodiments of the present disclosure.

According to some embodiments of the present disclosure, there is provided a method for controlling a molded case circuit breaker of an energy storage system, including: collecting, by a master BMS, voltage information associated with a plurality of battery racks from a plurality of slave BMSs associated with the plurality of battery racks; calculating an average voltage of the plurality of battery racks based on the voltage information associated with the plurality of battery racks; and determining a state of a first molded case circuit breaker (MCCB) associated with a first battery rack among the plurality of battery racks based on the voltage information associated with the plurality of battery racks and the average voltage, wherein the first molded case circuit breaker is in a trip state.

In some embodiments, the determining of the state includes: calculating a first voltage error of the first battery rack based on the voltage information associated with the plurality of battery racks and the average voltage; and determining the state of the first molded case circuit breaker based on the first voltage error and a first threshold.

In some embodiments, the first threshold is determined based on at least one of voltage information associated with the first molded case circuit breaker, temperature information of the energy storage system, voltage information associated with an external power device connected to the first molded case circuit breaker, or voltage information associated with the first battery rack.

In some embodiments, the determining of the state includes: maintaining the trip state of the first molded case circuit breaker in response to the first voltage error being greater than the first threshold.

In some embodiments, the maintaining of the trip state includes: repeatedly transmitting a state maintenance command from the master BMS to the first molded case circuit breaker.

In some embodiments, the determining of the state includes: switching the trip state of the first molded case circuit breaker to a closed state in response to the first voltage error being equal to or less than the first threshold.

In some embodiments, the plurality of battery racks further includes a second battery rack, wherein the plurality of slave BMSs includes a first slave BMS associated with the first battery rack and a second slave BMS associated with the second battery rack, and wherein the method further includes: monitoring, by the second slave BMS, the first slave BMS; and based on a result of the monitoring, determining, by the second slave BMS, the state of a second molded case circuit breaker associated with the second battery rack.

In some embodiments, the determining of the state of the second molded case circuit breaker includes: in response to switching of the trip state of the first molded case circuit breaker to a closed state, determining a trip state of the second molded case circuit breaker based on voltage information associated with the first battery rack and voltage information associated with the second battery rack.

In some embodiments, the determining of the state of the second molded case circuit breaker includes: calculating a second voltage error of the second battery rack based on voltage information associated with the first battery rack and voltage information associated with the second battery rack; and determining the state of the second molded case circuit breaker based on the second voltage error and a second threshold.

In some embodiments, the determining of the state of the second molded case circuit breaker includes: switching the state of the second molded case circuit breaker to a trip state in response to the second voltage error being greater than the second threshold.

In some embodiments, the determining of the state of the second molded case circuit breaker includes: switching the state of the second molded case circuit breaker to an open state in response to the second voltage error being equal to or less than the second threshold.

According to some embodiments of the present disclosure, there is provided a computer-readable non-transitory recording medium having recorded thereon instructions for executing the method of claim 1 on a computer.

According to some embodiments of the present disclosure, there is provided an energy storage system including: a plurality of battery racks including a first battery rack; a plurality of slave BMSs associated with the plurality of battery racks; a plurality of molded case circuit breakers configured to control power of the plurality of battery racks; and a master BMS configured to control the plurality of molded case circuit breakers, wherein the master BMS is configured to: collect voltage information associated with the plurality of battery racks from the plurality of slave BMSs; calculate an average voltage of the plurality of battery racks based on the voltage information associated with the plurality of battery racks; and determine a state of a first molded case circuit breaker associated with the first battery rack based on the voltage information associated with the plurality of battery racks and the average voltage, and wherein the first molded case circuit breaker is in a trip state.

In some embodiments, the master BMS configured to calculate a first voltage error of the first battery rack based on the voltage information associated with the plurality of battery racks and the average voltage, and to determine the state of the first molded case circuit breaker based on the first voltage error and a first threshold.

In some embodiments, the master BMS maintains a trip state of the first molded case circuit breaker in response to the first voltage error being greater than the first threshold.

In some embodiments, the master BMS switches the trip state of the first molded case circuit breaker to a closed state in response to the first voltage error being equal to or less than the first threshold.

In some embodiments, the plurality of battery racks further includes a second battery rack, wherein the plurality of slave BMSs includes a first slave BMS associated with the first battery rack and a second slave BMS associated with the second battery rack, and wherein the second slave BMS is configured to monitor the first slave BMS and to determine a state of a second molded case circuit breaker associated with the second battery rack based on a result of the monitoring.

In some embodiments, the second slave BMS is configured to determine a trip state of the second molded case circuit breaker based on voltage information associated with the first battery rack and voltage information associated with the second battery rack in response to switching of the trip state of the first molded case circuit breaker to a closed state.

In some embodiments, the second slave BMS is configured to: calculate a second voltage error of the second battery rack based on voltage information associated with the first battery rack and voltage information associated with the second battery rack, and determine the state of the second molded case circuit breaker based on the second voltage error and a second threshold.

In some embodiments, the second slave BMS switches the state of the second molded case circuit breaker to a trip state in response to the second voltage error being greater than the second threshold.

According to some embodiments of the present disclosure, when a problem occurring in the energy storage system is resolved, the state of the molded case circuit breaker can be determined by considering the voltage of the battery rack without immediately switching the molded case circuit breaker in a trip state to a closed state. Accordingly, by supplying power to the battery rack when the voltage of the battery rack is stabilized, damage to components such as a fuse of the molded case circuit breaker can be prevented or substantially reduced.

According to some embodiments of the present disclosure, unnecessary current can be prevented from flowing between the battery racks by switching the state of the molded case circuit breaker to a trip state when the voltage difference between the battery racks is large. Accordingly, unnecessary power loss can be prevented or substantially reduced.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a configuration of an energy storage system according to some embodiments of the present disclosure.

FIG. 2 illustrates a method for controlling a molded case circuit breaker according to some embodiments of the present disclosure.

FIG. 3 illustrates a configuration in which a molded case circuit breaker is connected according to some embodiments of the present disclosure.

FIG. 4 illustrates a configuration of an energy storage system according to some embodiments of the present disclosure.

FIG. 5 illustrates a method for controlling a molded case circuit breaker according to some embodiments of the present disclosure.

FIG. 6 illustrates a method for controlling a molded case circuit breaker In some embodiments of the present disclosure.

FIG. 7 illustrates a method for controlling a molded case circuit breaker In

some embodiments of the present disclosure.

FIG. 8 illustrates controlling the state of a molded case circuit breaker for a plurality of battery racks In some embodiments of the present disclosure.

FIG. 9 is a flowchart illustrating a method for controlling a molded case circuit breaker In some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, a battery rack may refer to an energy storage source including a plurality of battery modules that accommodate a plurality of secondary batteries electrically connected in series and/or in parallel. In addition, in the present disclosure, a slave battery management system (BMS) may refer to a device for managing such a battery rack.

In the present disclosure, a molded case circuit breaker (MCCB) may refer to a protection device that controls the supply of power to a battery rack between the battery rack and an external power device. In the present disclosure, the molded case circuit breaker may be set to any one of an ‘open state’, a ‘trip state’, or a ‘closed state’. When the molded case circuit breaker is in an open state, a circuit between the battery rack and the external power device is opened, so that current supplied to the battery rack may be cut off. In some examples, when the molded case circuit breaker is in a closed state, the circuit between the battery rack and the external power device is closed, so that current may be supplied to the battery rack. In addition, when the molded case circuit breaker is in a trip state, the circuit between the battery rack and the external power device is opened, so that current supplied to the battery rack may be cut off. However, unlike an open state, even if a trip state of the molded case circuit breaker is released, the molded case circuit breaker is not immediately switched to a closed state, but may be switched to a closed state through an additional operation (e.g., physical operations). In addition, when a trip state of the molded case circuit breaker is released, the molded case circuit breaker may be switched to an open state.

Hereinafter, a voltage error of the battery rack is explained by dividing it into two scenarios: 1) when it is equal to or less than a set or predetermined threshold and 2) when it is greater than the set or predetermined threshold. However, this division is not limited to these two scenarios. For example, the configuration described when the voltage error of the battery rack is equal to or less than a set or predetermined threshold may be applied when the voltage error of the battery rack is below the set or predetermined threshold. Similarly, the configuration described when the voltage error of the battery rack is greater than the set or predetermined threshold may be applied when the voltage error of the battery rack is equal to or greater than the set or predetermined threshold.

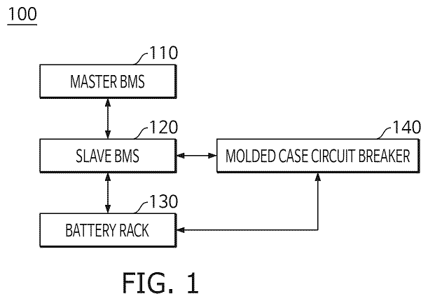

FIG. 1 is a diagram illustrating a configuration of an energy storage system 100 according to some embodiments of the present disclosure. In some embodiments, the energy storage system 100 may include a master BMS 110, a slave BMS 120, a battery rack 130, and a molded case circuit breaker 140. Here, the battery rack 130 may include a plurality of battery modules that are electrically connected. In addition, the slave BMS 120 may be connected to the battery rack 130, may receive information (e.g., voltage information) associated with the battery rack 130 from the battery rack 130, and may control the battery rack 130.

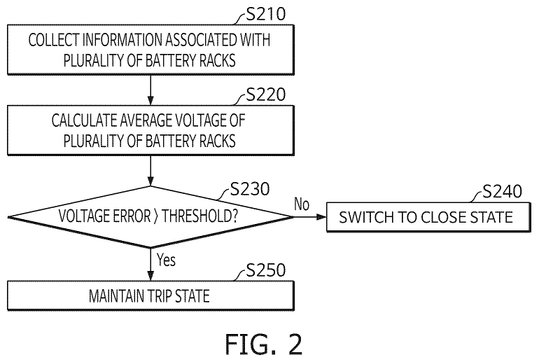

In some embodiments, the master BMS 110 may collect voltage information associated with the battery rack 130 from the slave BMS 120. In addition, the master BMS 110 may determine the state of the molded case circuit breaker 140 associated with the battery rack 130 based on the voltage information associated with the battery rack 130. Here, the molded case circuit breaker 140 may control power supplied to the battery rack 130 between the battery rack 130 and an external power device. An example of determining the state of the molded case circuit breaker 140 is described in further detail with reference to FIG. 2.

In some embodiments, the master BMS 110 and the slave BMS 120 may transmit and receive information using, for example, controller area network (CAN) communication. In addition, the slave BMS 120 may control the molded case circuit breaker 140 using a control signal. For example, the slave BMS 120 may transmit a control signal to the molded case circuit breaker 140 so that the molded case circuit breaker 140 switches to an open state, a closed state, or a trip state. The master BMS 110 may control the molded case circuit breaker 140 through the slave BMS 120.

FIG. 2 is a diagram illustrating an example of a method for controlling a molded case circuit breaker In some embodiments of the present disclosure. In some embodiments, the method for controlling a molded case circuit breaker of an energy storage system (e.g., 100 of FIG. 1) may be initiated by the master BMS collecting information associated with a plurality of battery racks from a plurality of slave BMSs associated with a plurality of battery racks (S210). Here, the information associated with the plurality of battery racks may include voltage information of each of the plurality of battery racks.

Then, the master BMS may calculate the average voltage of the plurality of battery racks based on the information associated with the plurality of battery racks (S220). In addition, the master BMS may calculate the voltage error of each of the plurality of battery racks based on the voltage information of each of the plurality of battery racks and the calculated average voltage. Here, the voltage error may be the difference between the voltage of the battery rack and the average voltage calculated by the master BMS.

Then, the master BMS may compare the calculated voltage error with a set or predetermined threshold (S230). In addition, the master BMS may determine the state of the molded case circuit breaker associated with the corresponding battery rack based on the result of comparing the calculated voltage error with the set or predetermined threshold. Here, the molded case circuit breaker may be in a trip state due to a problem occurring in the energy storage system or similar issues. In some examples, if the calculated voltage error is equal to or less than the set or predetermined threshold, the master BMS may switch a trip state of the molded case circuit breaker to a closed state (S240). In addition, if the calculated voltage error is greater than the set or predetermined threshold, the master BMS may maintain a trip state of the molded case circuit breaker (S250). In such examples, the master BMS may repeatedly transmit a state maintenance command to the molded case circuit breaker so that a trip state of the molded case circuit breaker is not released. The method for controlling the molded case circuit breaker described in FIG. 2 may be repeatedly performed in a short cycle (e.g., a short period of time).

With this configuration, the state of the molded case circuit breaker can be determined by considering the voltage of the battery rack without immediately switching the molded case circuit breaker in a trip state to a closed state when a problem occurring in the energy storage system is resolved. Accordingly, by supplying power to the battery rack when the voltage of the battery rack is stabilized, damage to components such as the fuse of the molded case circuit breaker can be prevented or substantially reduced.

At least a portion of the method described in the present disclosure may be implemented as a computer program stored on a computer-readable recording medium for execution on a computer. In some embodiments, at least a portion of the method may be stored on a computer-readable recording medium for execution on a computer. For example, the computer-readable recording medium may be a non-transitory computer-readable recording medium.

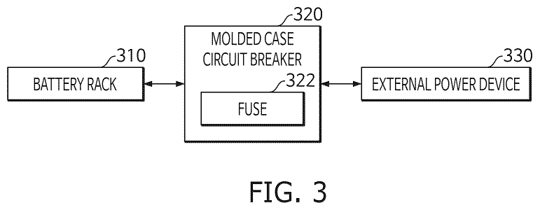

FIG. 3 illustrates a configuration in which a molded case circuit breaker 320 is connected according to some embodiments of the present disclosure. In some embodiments, the molded case circuit breaker 320 is placed between a battery rack 310 and an external power device 330 to control power supplied to the battery rack 310. For example, when a problem occurs in an energy storage system (e.g., 100 of FIG. 1) and the current flowing to the battery rack 310 is desired to be cut off, the molded case circuit breaker 320 may open a line that supplies power from the external power device 330 to the battery rack 310, thereby cutting off the power supplied to the battery rack 310. In another example, when a problem in the energy storage system is resolved, the molded case circuit breaker 320 may receive a command from the slave BMS (e.g., 120 of FIG. 1) and/or the master BMS (e.g., 110 of FIG. 1) to close the line supplying power from the external power device 330 to the battery rack 310 to resume the supply of power to the battery rack 310.

In some embodiments, the molded case circuit breaker 320 may include a fuse 322. Here, the fuse 322 may be damaged due to the inrush current that occurs at the moment when the molded case circuit breaker 320 closes the line supplying power from the external power device 330 to the battery rack 310. To prevent this, the master BMS may determine the state of the molded case circuit breaker 320 based on a set or predetermined threshold associated with the fuse 322 and the voltage of the battery rack 310. In some examples, the master BMS may calculate the voltage error of the battery rack 310 based on the voltage of the battery rack 310 and the average voltage of the plurality of battery racks. In addition, the master BMS may determine the state of the molded case circuit breaker 320 based on the voltage error of the battery rack 310 and the set or predetermined threshold. Here, the set or predetermined threshold is a rated voltage at which the fuse 322 may break/blow, and may be determined based on at least one of voltage information associated with the molded case circuit breaker, temperature information of the energy storage system, voltage information associated with an external power device connected to the molded case circuit breaker, or voltage information associated with the battery rack. Accordingly, the master BMS can determine the state of the molded case circuit breaker 320 so that the molded case circuit breaker 320 closes the line supplying power from the external power device 330 to the battery rack 310 at a time when the fuse 322 is not damaged.

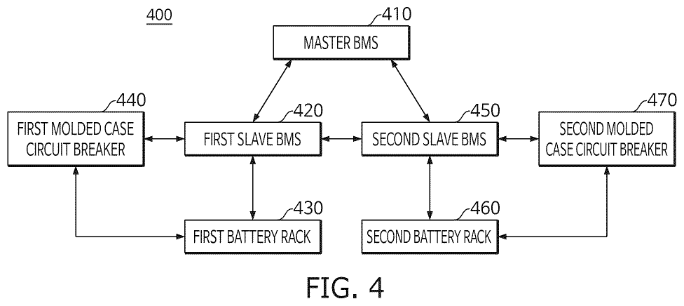

FIG. 4 is a diagram showing an example of a configuration of an energy storage system 400 according to some embodiments of the present disclosure. In some embodiments, the energy storage system 400 may include a master BMS 410, a first slave BMS 420, a first battery rack 430, a first molded case circuit breaker 440, a second slave BMS 450, a second battery rack 460, and a second molded case circuit breaker 470. Here, each of the first battery rack 430 and the second battery rack 460 may include a plurality of battery modules that are electrically connected.

In some embodiments, the first slave BMS 420 may be connected to the first battery rack 430, receive voltage information associated with the first battery rack 430 from the first battery rack 430, and control the first battery rack 430. Similarly, the second slave BMS 450 may be connected to the second battery rack 460, receive voltage information associated with the second battery rack 460 from the second battery rack 460, and control the second battery rack 460.

In some embodiments, the master BMS 410 may collect voltage information associated with the first battery rack 430 and voltage information associated with the second battery rack 460 from respective ones of the first slave BMS 420 and the second slave BMS 450. In addition, the master BMS 410 may determine the state of the first molded case circuit breaker 440 associated with the first battery rack 430 and the state of the second molded case circuit breaker 470 associated with the second battery rack 460 based on the voltage information associated with the first battery rack 430 and the voltage information associated with the second battery rack 460. Here, the first molded case circuit breaker 440 may control power supplied to the first battery rack 430 between the first battery rack 430 and an external power device, and the second molded case circuit breaker 470 may control power supplied to the second battery rack 460 between the second battery rack 460 and an external power device.

In some embodiments, the master BMS 410 may transmit and receive information with the first slave BMS 420 and the second slave BMS 450 using, for example, controller area network (CAN) communication. In addition, the first slave BMS 420 and the second slave BMS 450 may transmit and receive information using, for example, CAN communication. Through this, the second slave BMS 450 may monitor the information that the first slave BMS 420 transmits and receives to and from the master BMS 410.

In some embodiments, the first slave BMS 420 may control the first molded case circuit breaker 440 using a control signal. For example, the first slave BMS 420 may transmit a control signal to the first molded case circuit breaker 440 so that the first molded case circuit breaker 440 switches to an open state, a closed state, or a trip state. The second slave BMS 450 may similarly control the second molded case circuit breaker 470. The master BMS 410 may control the first molded case circuit breaker 440 and the second molded case circuit breaker 470 via the first slave BMS 420 and the second slave BMS 450.

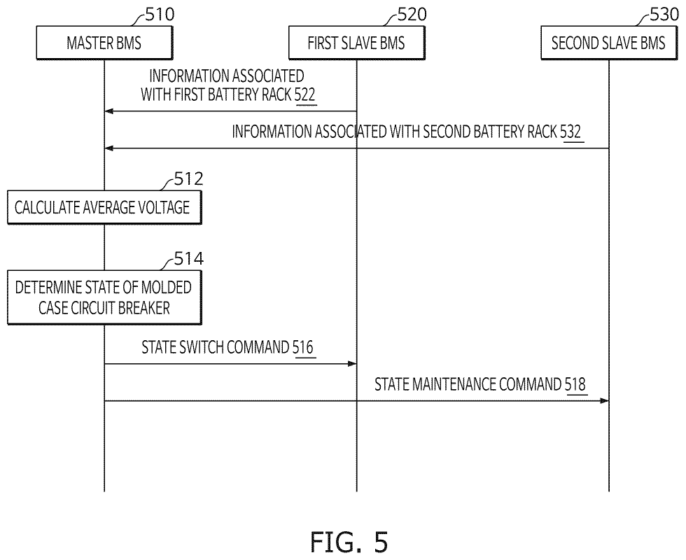

FIG. 5 illustrates a method for controlling a molded case circuit breaker according to some embodiments of the present disclosure. In some embodiments, the master BMS 510 may receive information 522 associated with the first battery rack from the first slave BMS 520. In addition, the master BMS 510 may receive information 532 associated with the second battery rack from the second slave BMS 530. Here, the information 522 associated with the first battery rack and the information 532 associated with the second battery rack may include voltage information of the first battery rack and voltage information of the second battery rack, respectively.

In some embodiments, the master BMS 510 may calculate an average voltage of the plurality of battery racks based on the information 522 associated with the first battery rack and the information 532 associated with the second battery rack (512). In addition, the master BMS 510 may determine the state of the first molded case circuit breaker associated with the first battery rack and the state of the second molded case circuit breaker associated with the second battery rack based on the information 522 associated with the first battery rack, the information 532 associated with the second battery rack, and the average voltage (514). Here, the current state of each of the first molded case circuit breaker and the second molded case circuit breaker may be a trip state.

In some embodiments, the master BMS 510 may calculate the voltage error of the first battery rack based on the average voltage and the information 522 associated with the first battery rack. That is, the voltage error of the first battery rack may be the difference between the voltage of the first battery rack and the average voltage. In addition, the master BMS 510 may determine the state of the first molded case circuit breaker based on the voltage error of the first battery rack and the set or predetermined threshold. For example, if the voltage error of the first battery rack is equal to or less than a set or predetermined threshold, the master BMS 510 may determine that the voltage of the first battery rack is stable, and may transmit a state switch command 516 associated with the first molded case circuit breaker to the first slave BMS 520 to switch a trip state of the first molded case circuit breaker to a closed state.

In some embodiments, the master BMS 510 may calculate the voltage error of the second battery rack based on the average voltage and the information 532 associated with the second battery rack. That is, the voltage error of the second battery rack may be the difference between the voltage of the second battery rack and the average voltage. In addition, the master BMS 510 may determine the state of the second molded case circuit breaker based on the voltage error of the second battery rack and the set or predetermined threshold. For example, if the voltage error of the second battery rack is greater than the set or predetermined threshold, the master BMS 510 may determine that the voltage of the second battery rack is unstable, and may transmit a state maintenance command 518 associated with the second molded case circuit breaker to the second slave BMS 530 to maintain a trip state of the second molded case circuit breaker. In such examples, the master BMS 510 may repeatedly transmit the state maintenance command 518 to the second slave BMS 530 in a short cycle (e.g., a short period of time).

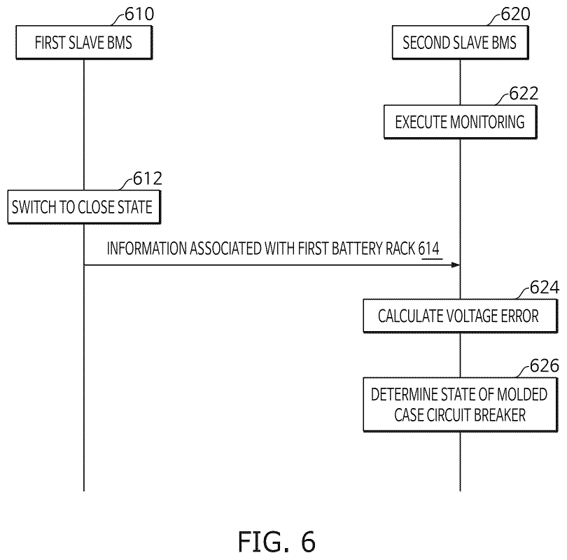

FIG. 6 is a diagram illustrating a method for controlling a molded case circuit breaker according to some embodiments of the present disclosure. In some embodiments, the second slave BMS 620 may perform monitoring of the first slave BMS 610 622. In such examples, the second slave BMS 620 may monitor the command transmitted by the first slave BMS 610 to the first molded case circuit breaker associated with the first slave BMS 610, the state of the first molded case circuit breaker, information associated with the first battery rack, and similar information. Here, the first slave BMS 610 and the second slave BMS 620 may be associated with the first battery rack and the second battery rack, respectively.

In some embodiments, the first slave BMS 610 may switch a trip state of the first molded case circuit breaker to a closed state (612). In such examples, the second slave BMS 620 may receive information 614 associated with the first battery rack through monitoring of the first slave BMS 610. In some embodiments, the first slave BMS 610 may transmit the information 614 associated with the first battery rack to the second slave BMS 620 in response to switching of a trip state of the first molded case circuit breaker to a closed state.

In some embodiments, the second slave BMS 620 may determine the state of the second molded case circuit breaker associated with the second slave BMS 620 based on the monitoring result. In some examples, the second slave BMS 620 may calculate a voltage error of the second battery rack based on the information 614 associated with the first battery rack and the information associated with the second battery rack (624). Here, the voltage error of the second battery rack may be a difference between the voltage of the first battery rack and the voltage of the second battery rack.

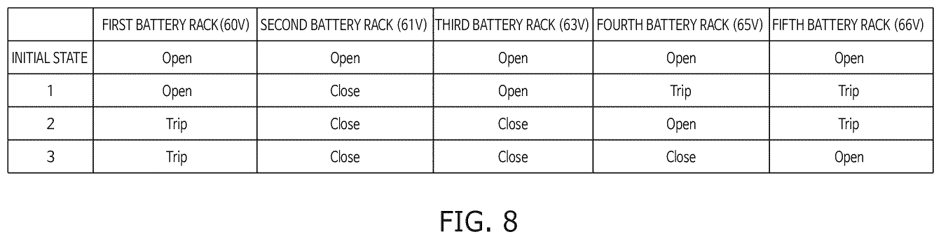

In some embodiments, the second slave BMS 620 may determine the state of the second molded case circuit breaker based on the voltage error of the second battery rack and the set or predetermined threshold (or threshold voltage) (626). For example, if the voltage error of the second battery rack is equal to or less than the set or predetermined threshold, the second slave BMS 620 may switch the state of the second molded case circuit breaker to an open state. In another example, if the voltage error of the second battery rack is greater than the set or predetermined threshold, the second slave BMS 620 may switch the state of the second molded case circuit breaker to a trip state. An example of the second slave BMS 620 determining the state of the second molded case circuit breaker is described in further detail with reference to FIG. 8.

With this configuration, when the voltage difference between the battery racks is large, unnecessary current can be prevented from flowing between the battery racks by switching the state of the molded case circuit breaker to a trip state. Accordingly, unnecessary power loss can be prevented or substantially reduced.

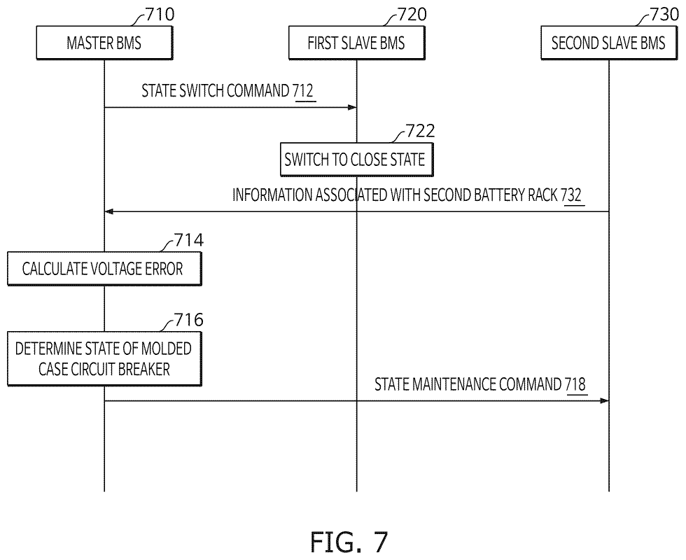

FIG. 7 is a diagram showing an example of a method for controlling a molded case circuit breaker according to some embodiments of the present disclosure. In some embodiments, the master BMS 710 may transmit a state switch command 712 to the first slave BMS 720 to switch a trip state of the first molded case circuit breaker associated with the first slave BMS 720 to a closed state. In such examples, in response to receiving the state switch command 712, the first slave BMS 720 may switch the trip state of the first molded case circuit breaker to a closed state (722).

In some embodiments, the master BMS 710 may receive information 732 associated with the second battery rack from the second slave BMS 730 associated with the second battery rack. In response to receiving the information 732 associated with the second battery rack, the master BMS 710 may calculate a voltage error of the second battery rack (714). Here, the voltage error may be a difference between the voltage of the first battery rack and the voltage of the second battery rack.

In some embodiments, the master BMS 710 may determine the state of the second molded case circuit breaker associated with the second slave BMS 730 based on the voltage error of the second battery rack and a set or predetermined threshold (or threshold voltage) (716). For example, if the voltage error of the second battery rack is equal to or less than the set or predetermined threshold, the master BMS 710 may transmit a state switch command 718 to the second slave BMS 730 to switch the state of the second molded case circuit breaker to an open state. In another example, if the voltage error of the second battery rack is greater than the set or predetermined threshold, the master BMS 710 may switch the state of the second molded case circuit breaker to a trip state.

FIG. 8 is a diagram illustrating an example of controlling the state of a molded case circuit breaker for a plurality of battery racks according to some embodiments of the present disclosure. In some embodiments, as described above in FIG. 6, a slave BMS may monitor different slave BMSs to determine the state of a molded case circuit breaker associated with the slave BMS. Referring to FIG. 8, a first molded case circuit breaker to a fifth molded case circuit breaker associated with the first to fifth battery racks having different voltages may all be in an open state.

In some embodiments, the state of the second molded case circuit breaker may be switched to a closed state. When the slave BMS determines the state of the molded case circuit breaker, if the set or predetermined threshold compared with the voltage error of the battery rack is 2 V, the state of the fourth molded case circuit breaker and the fifth molded case circuit breaker associated with the fourth battery rack and the fifth battery rack having a voltage greater than the voltage of the second battery rack and a set or predetermined threshold may be switched to a trip state.

Then, the state of the third molded case circuit breaker may be switched to a closed state. In such examples, the state of the fourth molded case circuit breaker associated with the fourth battery rack having a voltage equal to or less than the voltage of the third battery rack and the set or predetermined threshold may be switched to an open state. In addition, the state of the first molded case circuit breaker associated with the first battery rack having a voltage greater than the voltage of the third battery rack and the set or predetermined threshold may be switched to a trip state. In some embodiments, the state of the fifth molded case circuit breaker associated with the fifth battery rack having a voltage greater than the voltage of the third battery rack and the set or predetermined threshold may be maintained in a trip state. In addition, the state of the second molded case circuit breaker, which is already in a closed state, may be maintained.

Thereafter, the state of the fourth molded case circuit breaker may be switched to a closed state. In such examples, the state of the fifth molded case circuit breaker associated with the fifth battery rack having a voltage equal to or lower than the voltage of the fourth battery rack and the set or predetermined threshold may be switched to an open state. In some embodiments, the state of the first molded case circuit breaker associated with the first battery rack having a voltage greater than the voltage of the fourth battery rack and the set or predetermined threshold may be maintained in a trip state. In addition, the states of the second molded case circuit breaker and the third molded case circuit breaker, which are already in a closed state, may be maintained.

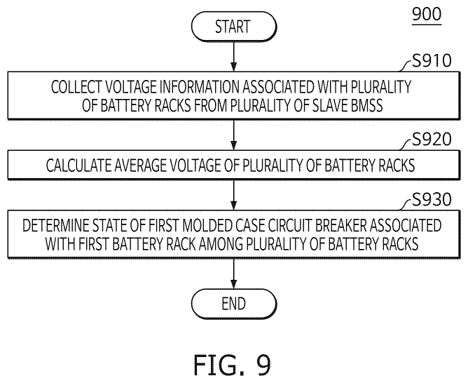

FIG. 9 is a flowchart illustrating a method 900 for controlling a molded case circuit breaker according to some embodiments of the present disclosure. In some embodiments, the method 900 for controlling the molded case circuit breaker may be initiated by a master BMS collecting voltage information associated with a plurality of battery racks from a plurality of slave BMSs associated with a plurality of battery racks (S910). In addition, the master BMS may calculate an average voltage of the plurality of battery racks based on voltage information associated with the plurality of battery racks (S920).

Thereafter, the master BMS may determine the state of a first molded case circuit breaker associated with a first battery rack among the plurality of battery racks based on the voltage information and average voltage associated with the plurality of battery racks (S930). Here, the first molded case circuit breaker may be in a trip state.

In some embodiments, the master BMS may calculate a first voltage error of the first battery rack based on the voltage information and average voltage associated with the plurality of battery racks. In addition, the master BMS may determine the state of the first molded case circuit breaker based on the first voltage error and a set or predetermined first threshold. Here, the set or predetermined first threshold may be determined based on at least one of the voltage information associated with the first molded case circuit breaker, the temperature information of the energy storage system, the voltage information associated with the external power device connected to the first molded case circuit breaker, or the voltage information associated with the first battery rack.

In some embodiments, the master BMS may maintain a trip state of the first molded case circuit breaker when the first voltage error is greater than the set or predetermined first threshold. In such examples, the master BMS may repeatedly transmit a state maintenance command to the first molded case circuit breaker. In some embodiments, the master BMS may switch the trip state of the first molded case circuit breaker to a closed state when the first voltage error is equal to or less than the set or predetermined first threshold.

In some embodiments, the plurality of battery racks may further include a second battery rack, and the plurality of slave BMSs may include a first slave BMS associated with the first battery rack and a second slave BMS associated with the second battery rack. In such examples, the second slave BMS may monitor the first slave BMS. In addition, based on the monitoring result, the second slave BMS may determine the state of a second molded case circuit breaker associated with the second battery rack. In some examples, the second slave BMS may determine a trip state of the second molded case circuit breaker based on voltage information associated with the first battery rack and the voltage information associated with the second battery rack in response to switching of the trip state of the first molded case circuit breaker to a closed state.

In some embodiments, the second slave BMS may calculate a second voltage error of the second battery rack based on the voltage information associated with the first battery rack and the voltage information associated with the second battery rack. In addition, based on the second voltage error and a set or predetermined second threshold, the second slave BMS may determine the state of the second molded case circuit breaker. For example, if the second voltage error is greater than the set or predetermined second threshold, the second slave BMS may switch the state of the second molded case circuit breaker to a trip state. In another example, if the second voltage error is equal to or less than the set or predetermined second threshold, the second slave BMS may switch the state of the second molded case circuit breaker to an open state.

At least a portion of the method described in the present disclosure may be implemented as a computer program stored on a computer-readable recording medium for execution on a computer. In some embodiments, at least a portion of the method may be stored on a computer-readable recording medium for execution on a computer. For example, the computer-readable recording medium may be a non-transitory computer-readable recording medium.

In some embodiments, the recording medium may be a type of medium that continuously stores a program executable by a computer, or temporarily stores the program for execution or download. In addition, the medium may be a variety of writing means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and the like. In addition, other examples of the medium may include an app store that distributes applications, a site that supplies or distributes various pieces of software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies according to design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more application-specific integrated circuits (ASICs), DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random-access memory (RAM), read-only memory (ROM), non-volatile random-access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium.

For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor may read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or apparatus, and storage may be similarly influenced across a plurality of apparatus. Such apparatus may include PCs, network servers, and portable apparatus.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

100: Energy storage system
110: Master BMS
120: Slave BMS
130: Battery rack
140: Molded case circuit breaker

What is claimed is:

1. A method for controlling a molded case circuit breaker of an energy storage system, comprising:
collecting, by a master BMS, voltage information associated with a plurality of battery racks from a plurality of slave BMSs associated with the plurality of battery racks;
calculating an average voltage of the plurality of battery racks based on the voltage information associated with the plurality of battery racks; and
determining a state of a first molded case circuit breaker (MCCB) associated with a first battery rack among the plurality of battery racks based on the voltage information associated with the plurality of battery racks and the average voltage,
wherein the first molded case circuit breaker is in a trip state.

2. The method of claim 1, wherein the determining of the state comprises:
calculating a first voltage error of the first battery rack based on the voltage information associated with the plurality of battery racks and the average voltage; and
determining the state of the first molded case circuit breaker based on the first voltage error and a first threshold.

3. The method of claim 2, wherein the first threshold is determined based on at least one of voltage information associated with the first molded case circuit breaker, temperature information of the energy storage system, voltage information associated with an external power device connected to the first molded case circuit breaker, or voltage information associated with the first battery rack.

4. The method of claim 2, wherein the determining of the state comprises:
maintaining the trip state of the first molded case circuit breaker in response to the first voltage error being greater than the first threshold.

5. The method of claim 4, wherein the maintaining of the trip state comprises:
repeatedly transmitting a state maintenance command from the master BMS to the first molded case circuit breaker.

6. The method of claim 2, wherein the determining of the state comprises:
switching the trip state of the first molded case circuit breaker to a closed state in response to the first voltage error being equal to or less than the first threshold.

7. The method of claim 1, wherein the plurality of battery racks further comprises a second battery rack,
wherein the plurality of slave BMSs comprises a first slave BMS associated with the first battery rack and a second slave BMS associated with the second battery rack, and
wherein the method further comprises:
monitoring, by the second slave BMS, the first slave BMS; and
based on a result of the monitoring, determining, by the second slave BMS, the state of a second molded case circuit breaker associated with the second battery rack.

8. The method of claim 7, wherein the determining of the state of the second molded case circuit breaker comprises:
in response to switching of the trip state of the first molded case circuit breaker to a closed state, determining a trip state of the second molded case circuit breaker based on voltage information associated with the first battery rack and voltage information associated with the second battery rack.

9. The method of claim 8, wherein the determining of the state of the second molded case circuit breaker comprises:
calculating a second voltage error of the second battery rack based on voltage information associated with the first battery rack and voltage information associated with the second battery rack; and
determining the state of the second molded case circuit breaker based on the second voltage error and a second threshold.

10. The method of claim 9, wherein the determining of the state of the second molded case circuit breaker comprises:
switching the state of the second molded case circuit breaker to a trip state in response to the second voltage error being greater than the second threshold.

11. The method of claim 9, wherein the determining of the state of the second molded case circuit breaker comprises:
switching the state of the second molded case circuit breaker to an open state in response to the second voltage error being equal to or less than the second threshold.

12. A computer-readable non-transitory recording medium having recorded thereon instructions for executing the method of claim 1 on a computer.

13. An energy storage system comprising:
a plurality of battery racks comprising a first battery rack;
a plurality of slave BMSs associated with the plurality of battery racks;
a plurality of molded case circuit breakers configured to control power of the plurality of battery racks; and
a master BMS configured to control the plurality of molded case circuit breakers,
wherein the master BMS is configured to:
collect voltage information associated with the plurality of battery racks from the plurality of slave BMSs;
calculate an average voltage of the plurality of battery racks based on the voltage information associated with the plurality of battery racks; and
determine a state of a first molded case circuit breaker associated with the first battery rack based on the voltage information associated with the plurality of battery racks and the average voltage, and
wherein the first molded case circuit breaker is in a trip state.

14. The energy storage system of claim 13, wherein the master BMS configured to calculate a first voltage error of the first battery rack based on the voltage information associated with the plurality of battery racks and the average voltage, and to determine the state of the first molded case circuit breaker based on the first voltage error and a first threshold.

15. The energy storage system of claim 14, wherein the master BMS maintains a trip state of the first molded case circuit breaker in response to the first voltage error being greater than the first threshold.

16. The energy storage system of claim 14, wherein the master BMS switches the trip state of the first molded case circuit breaker to a closed state in response to the first voltage error being equal to or less than the first threshold.

17. The energy storage system of claim 13, wherein the plurality of battery racks further comprises a second battery rack,
wherein the plurality of slave BMSs comprises a first slave BMS associated with the first battery rack and a second slave BMS associated with the second battery rack, and
wherein the second slave BMS is configured to monitor the first slave BMS and to determine a state of a second molded case circuit breaker associated with the second battery rack based on a result of the monitoring.

18. The energy storage system of claim 17, wherein the second slave BMS is configured to determine a trip state of the second molded case circuit breaker based on voltage information associated with the first battery rack and voltage information associated with the second battery rack in response to switching of the trip state of the first molded case circuit breaker to a closed state.

19. The energy storage system of claim 18, wherein the second slave BMS is configured to:
calculate a second voltage error of the second battery rack based on voltage information associated with the first battery rack and voltage information associated with the second battery rack, and
determine the state of the second molded case circuit breaker based on the second voltage error and a second threshold.

20. The energy storage system of claim 19, wherein the second slave BMS switches the state of the second molded case circuit breaker to a trip state in response to the second voltage error being greater than the second threshold.
